(19) United States
(12) Patent Application Publication
(10) Pub. No.: US 2013/0138441 A1
(43) Pub. Date: May 30, 2013

(54) METHOD AND SYSTEM FOR GENERATING SEARCH NETWORK FOR VOICE RECOGNITION

(71) Applicants: Seung Hi Kim, Daejeon (KR); Dong Hyun Kim, Seoul (KR); Young Ik Kim, Daejeon (KR); Jun Park, Daejeon (KR); Hoon Young Cho, Daejeon (KR); Sang Hun Kim, Daejeon (KR)

(72) Inventors: Seung Hi Kim, Daejeon (KR); Dong Hyun Kim, Seoul (KR); Young Ik Kim, Daejeon (KR); Jun Park, Daejeon (KR); Hoon Young Cho, Daejeon (KR); Sang Hun Kim, Daejeon (KR)

(73) Assignee: ELECTRONICS AND TELECOMMUNICATIONS RESEARCH INSTITUTE, Daejeon (KR)

(21) Appl. No.: 13/585,475

(22) Filed: Aug. 14, 2012

(30) Foreign Application Priority Data
Nov. 28, 2011 (KR) 10-2011-0125405

(51) Int. Cl. G10L 15/04

(52) U.S. Cl. 704/254; 704/E15.005

(57) ABSTRACT

Disclosed is a method of generating a search network for voice recognition, the method including: generating a pronunciation transduction weighted finite state transducer by implementing a pronunciation transduction rule representing a phenomenon of pronunciation transduction between recognition units as a weighted finite state transducer; and composing the pronunciation transduction weighted finite state transducer and one or more weighted finite state transducers.

### CROSS-REFERENCE TO RELATED APPLICATIONS

This application claims priority to and the benefit of Korean Patent Application No. 10-2011-0125405 filed in the Korean Intellectual Property Office on Nov. 28, 2011, the entire contents of which are incorporated herein by reference.

### TECHNICAL FIELD

The present invention relates to a voice recognition technology, and more particularly, to a method and a system for generating a search network for a voice recognition system.

### BACKGROUND ART

As is well known, a voice recognition system searches a search network representing a target region to be recognized for a sequence of words which is the most similar to an input voice signal (voice data).

There are several methods of forming the search network. Among them, a method of forming a search network by using a weighted finite State transducer (WFST) has been common. A basic process of forming the search network by using the WFST includes a process of generating element WFSTs configuring the search network and a process of composing the element WFSTs.

When a word is pronounced, a pronunciation of the word in a form of an isolated word may be different from a pronunciation of the word in a form of a continuous word. For example, on the assumption that in English, a pronunciation of “did” is [ . . . d] and a pronunciation of “you” is [y . . . ], when the two words are continuously pronounced, [d] and [y] meet at a boundary of the words, so that a phenomenon of changing [d] and [y] to [jh] may occur. In a continuous voice recognition field, pronunciation transduction between recognition units should be considered for improving the accuracy of recognition. One of the pronunciation transduction methods is a multiple pronunciation dictionary. The multiple pronunciation dictionary may additionally include [ . . . jh] as the pronunciation of “did”, as well as [ . . . d], considering the pronunciation transduction. However, the use of the multiple pronunciation dictionary may have a problem of generating an unintended pronunciation sequence, [ . . . jh ay], in the search network, as well as a normal pronunciation sequence, [ . . . d ay], in a process of composing “did” and “I [ay]”. Accordingly, when the multiple-pronunciation dictionary is used, there is a problem of generating a pronunciation sequence that is not actually pronounced, resulting in an increase of a possibility of wrong recognition.

### SUMMARY OF THE INVENTION

The present invention has been made in an effort to provide a method and a system for generating a search network for voice recognition capable of improving accuracy of voice recognition by adding a pronunciation sequence generated according to pronunciation transduction between recognition units to the search network.

An exemplary embodiment of the present invention provides a method of generating a search network for voice recognition, the method including: generating a pronunciation transduction weighted finite state transducer by implementing a pronunciation transduction rule representing a phenomenon of pronunciation transduction between recognition units as a weighted finite state transducer; and composing the pronunciation transduction weighted finite state transducer and one or more weighted finite state transducers.

The pronunciation transduction rule may be represented in a form of a phoneme sequence.

The recognition unit may be a word.

The generating of the pronunciation transduction weighted finite state transducer may include generating the pronunciation transduction weighted finite state transducer based on a context independent phoneme and the pronunciation transduction rule.

An input and an output of the pronunciation transduction weighted finite state transducer may be context independent phonemes.

The composing of the pronunciation transduction weighted finite state transducer and the one or more weighted finite state transducers may include composing a grammar weighted finite state transducer and a pronunciation dictionary weighted finite state transducer; and composing the pronunciation transduction weighted finite state transducer and the composed weighted finite state transducer.

The composing of the pronunciation transduction weighted finite state transducer and the one or more weighted finite state transducers may further include composing a context weighted finite state transducer and a weighted finite state transducer that is composed with the pronunciation transduction weighted finite state transducer.

The composing of the pronunciation transduction weighted finite state transducer and the one or more weighted finite state transducers may further include composing an HMM weighted finite state transducer and a weighted finite state transducer that is composed with the context weighted finite state transducer.

The method of generating the search network for the voice recognition may further include optimizing a weighted finite state transducer that is composed with the pronunciation transduction weighted finite state transducer.

Another exemplary embodiment of the present invention provides a system for generating a search network for voice recognition, the system including: a storage unit for storing a pronunciation transduction weighted finite state transducer in which a pronunciation transduction rule representing a phenomenon of pronunciation transduction between recognition units is implemented as a weighted finite state transducer; and a WFST composition unit for composing the pronunciation transduction weighted finite state transducer to one or more weighted finite state transducers.

According to exemplary embodiments of the present invention, it is possible to improve accuracy of the voice recognition by adding the pronunciation sequence generated according to the pronunciation transduction between the recognition units to the search network.

It is possible to easily reflect the pronunciation transduction to the voice recognition system by implementing the pronunciation transduction rule as the element WFST and composing the element WFST with another element WFST, and complexity of the voice recognition engine is not increased.

It is possible to prevent the generation of the unintended pronunciation sequences, such as the multiple pronunciation dictionary, by adding only the pronunciation sequence generated according to the pronunciation transduction between the recognition units.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a system for generating a pronunciation transduction WFST according to an exemplary embodiment of the present invention.

FIG. 2 is a block diagram illustrating a system for generating a search network for voice recognition according to an exemplary embodiment of the present invention.

FIG. 3 is a flowchart illustrating a method of generating a search network for voice recognition according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description and accompanying drawings, substantially like elements are designated by like reference numerals, so that repetitive description will be omitted. In the following description of the present invention, a detailed description of known functions and configurations incorporated herein will be omitted when it may make the subject matter of the present invention rather unclear.

Throughout the specification of the present invention, a weighted finite state transducer is called a “WFST”.

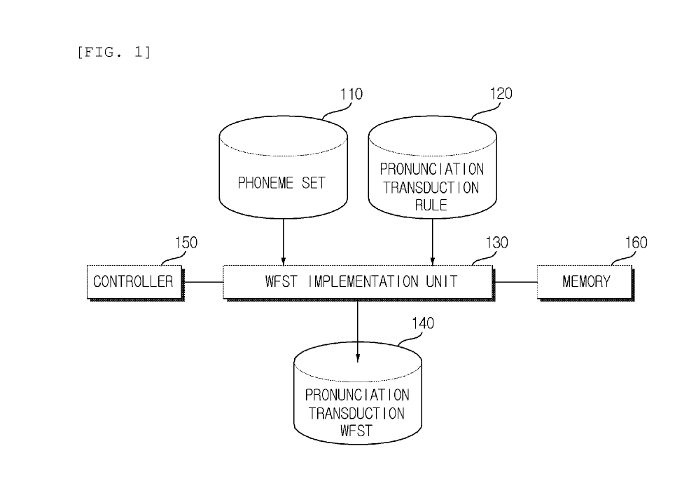

FIG. 1 is a block diagram illustrating a system for generating a pronunciation transduction WFST according to an exemplary embodiment of the present invention. The system according to the exemplary embodiment of the present invention includes a phoneme set storage unit 110, a pronunciation transduction rule storage unit 120, a WFST implementation unit 130, a pronunciation transduction WFST storage unit 140, a controller 150, and a memory 160.

The phoneme set storage unit 110 stores a set of phonemes constructing a pronunciation sequence. A phoneme discriminated regardless of a context is called a context independent phoneme, and a phoneme defined considering phonemes on left and right sides based on the context independent phoneme is called a context dependent phoneme. The phoneme set storage unit 110 preferably stores a set of context independent phonemes.

The pronunciation transduction rule storage unit 120 stores a pronunciation transduction rule representing a phenomenon of pronunciation transduction between recognition units. Here, the recognition unit may be a “word”. The pronunciation transduction rule corresponds to a pronunciation transduction rule based on a phoneme sequence expressed with the context independent phoneme.

To use “did” and “you” described in the aforementioned example as an example, when the two words, “did” and “you”, are connected and vocalized, they are pronounced as [ . . . jh y . . . ]. In a case of the pronunciation transduction, a phoneme of [d] has an important meaning, rather than a word, “did”. Accordingly, it is preferable to describe the pronunciation transduction rule with the phoneme sequence involved in the pronunciation transduction, rather than describe the pronunciation transduction rule with the word, “did”, or the entire pronunciation sequence of “did”. If a boundary between words is expressed as a “WB”, the pronunciation transduction rule corresponding to the present example may be expressed as follows.

d WB y [symbol] jh WB y

It is a matter of course that in order to avoid confusion, the pronunciation transduction rule may also be expressed with a longer phoneme sequence, and the pronunciation transduction rule may also be expressed with an entire pronunciation sequence of a word depending on occasions according to a type of pronunciation transduction rules.

To use Korean as an example, in a case of “ [symbol] ”+“ [symbol] ” that is a postposition, “a final consonant of [symbol] ” and “ [symbol] ” are composed, so that [initial consonant [symbol] ] is pronounced. In this case, the pronunciation transduction rule may be expressed as follows.

Final consonant [symbol] WB [symbol] Initial consonant [symbol] WB

[symbol]

Under a control of the controller 150, the WFST implementation unit 130 generates the WFST based on the set of the phonemes stored in the phoneme set storage unit 110 and the pronunciation transduction rule stored in the pronunciation transduction rule storage unit 120. The generated WFST corresponds to a pronunciation transduction WFST according to the present invention. The WFST implementation unit 130 may correspond to a WFST generation circuit, routine, or application.

Particularly, the WFST implementation unit 130 extracts a part of or the entire set of the phonemes from the phoneme set storage unit 110 or extracts the pronunciation transduction rules from the pronunciation transduction rule storage unit 120. The WFST implementation unit 130 generates the WFST based on the extracted pronunciation transduction rules. A route for each pronunciation transduction rule is generated within the WFST. For a predetermined pronunciation transduction rule, edges are generated within a route expressing the predetermined pronunciation transduction rule and the edges are labeled with corresponding signs. The generated route, the edge, the label, etc., may be stored in the memory 160 depending on the necessity.

The WFST implementation unit 130 outputs the pronunciation transduction WFST generated as described above to the pronunciation transduction WFST storage unit 140. The pronunciation transduction WFST storage unit 140 stores the pronunciation transduction WFST. As described above, the pronunciation transduction WFST is generated based on the pronunciation transduction rule based on the phoneme sequence expressed with the context independent phonemes, so that an input and an output of the pronunciation transduction WFST are the context independent phonemes.

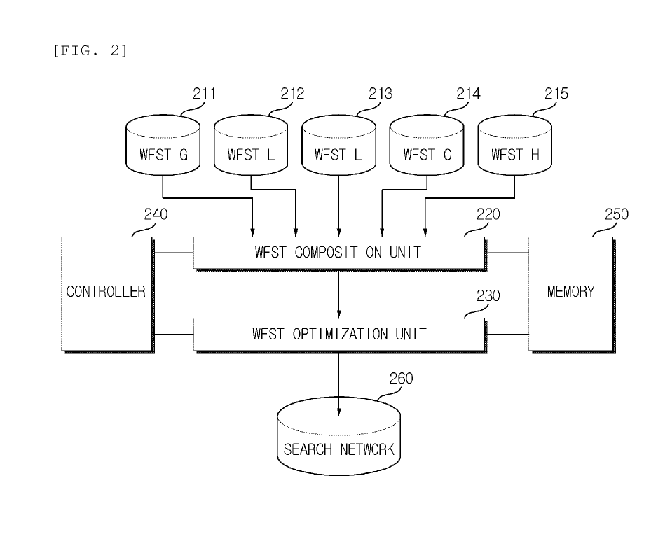

FIG. 2 is a block diagram illustrating a system for generating a search network for voice recognition according to an exemplary embodiment of the present invention.

The system for generating the search network for voice recognition according to the exemplary embodiment of the present invention includes storage units 211 to 215 for storing respective element WFSTs, a WFST composition unit 220, a WFST optimization unit 230, a search network storage unit 260, a controller 240, and a memory 250.

An example of an existing element WFST includes a grammar WFST (hereinafter, WFST G) for expressing a target sentence for a search in respect to a relationship between words, a pronunciation dictionary WFST (hereinafter, WFST L) for expressing respective words by using the context independent phoneme, a context WFST (hereinafter, WFST C) for transducing the context independent phonemes to the context dependent phonemes, and a hidden Markov model (HMM) WFST (hereinafter, WFST H) for transducing a context dependent phoneme sequence to a state sequence of the HMM. Here, G, L, and C refer to Grammar, Lexicon, and Context, respectively. Depending on occasions, a process of composing the HMM WFST may be omitted in a process of forming the search network, and a process of transducing a context dependent phoneme sequence to the state sequence of the HMM may be performed in a voice recognition engine. The WFST scheme has advantages capable of forming the entire complex search network through the composition of the simple element WFSTs, and easily generating and correcting the search network due to the separate generation and management of the respective element WFSTs.

The storage units 211, 212, 214, and 215 store the WFST G, the WFST L, the WFST C, and the WFST H, respectively. The storage unit 213 stores the pronunciation transduction WFST generated as described above. The pronunciation transduction WFST is also called WFST L′ for convenience's sake. Although it is described in the exemplary embodiment of the present invention that the WFST G, the WFST L, the WFST L′, the WFST C, and the WFST H are stored in the separate storage media, they may be stored in the same storage medium as a matter of course.

Under the control of the controller 150, the WFST composition unit 220 composes the respective element WFSTs stored in the storage units 211 to 215. The WFST composition unit 220 may correspond to a WFST composition circuit, routine, or application.

The composition of the WFSTs means that, for the two WFST S and WFST T as an example, when the WFST S corresponds from an input x to an output y and the WFST T corresponds from an input x to the output z, the composition of the WFST T and the WFST S becomes one WFST having the input x and the output z. The composition of the WFSTs is expressed with a symbol “∘”, and Z=S∘T means one WFST z generated as a result of the composition of the WFST T and WFST S.

The WFST composition unit 220 first composes the WFST G and the WFST L. As a result, WFST L∘G is generated. Then, the WFST composition unit 220 composes the WFST L′ and the WFST L∘G. As a result, WFST L′∘L∘G is generated. Then, the WFST composition unit 220 composes the WFST C and the WFST L′∘L∘G. As a result, WFST C∘L′∘L∘G is generated. Then, the WFST composition unit 220 composes the WFST H and the WFST C∘L′∘L∘G. As a result, WFST H∘C∘L′∘L∘G is generated.

Depending on a case, the process of transducing the context dependent phoneme sequence to the state sequence of the HMM may be implemented in the voice recognition engine, and the process of composing the WFST H and the WFST C∘L′∘L∘G may be omitted.

The WFST L∘G, the WFST L′∘L∘G, the WFST C∘L′∘L∘G, and the WFST H∘C∘L′∘L∘G generated in the WFST composition unit 220 may be stored in the memory 250.

Under the control of the controller 150, the WFST optimization unit 230 optimizes a final WFST generated in the WFST composition unit 220. The WFST optimization unit 230 may correspond to a WFST optimization circuit, routine, or application.

The final WFST may be the WFST H∘C∘L′∘L∘G, and also may be the WFST C∘L′∘L∘G depending on a case. The WFST optimization unit 230 may optimize the WFST L∘G, the WFST L′∘L∘G, and the WFST C∘L′∘L∘G during the composition process and perform the composition process with the optimized WFSTs depending on a case.

The optimization process includes determinization and minimization. The determinization means a process of making a non-deterministic WFST be a deterministic WFST. The minimization means a process of making a determinized WFST be a WFST having a minimum state and a minimum transition. The determinized WFST and the minimized WFST may be stored in the memory 250.

The WFST optimization unit 230 outputs the optimized final WFST to the search network storage unit 260. The search network storage unit 260 stores the optimized final WFST as the search network for voice recognition.

The search network generated as described above is the search network to which the pronunciation sequences according to the phenomenon of the pronunciation transduction between the recognition units are added by comparison with the search network to which the pronunciation transduction WFST according to the present invention is not applied. Since the search network generated as described above is not superficially different from the search network to which the pronunciation transduction WFST is not applied, the search network may be applied to the voice recognition engine without correcting the voice recognition engine.

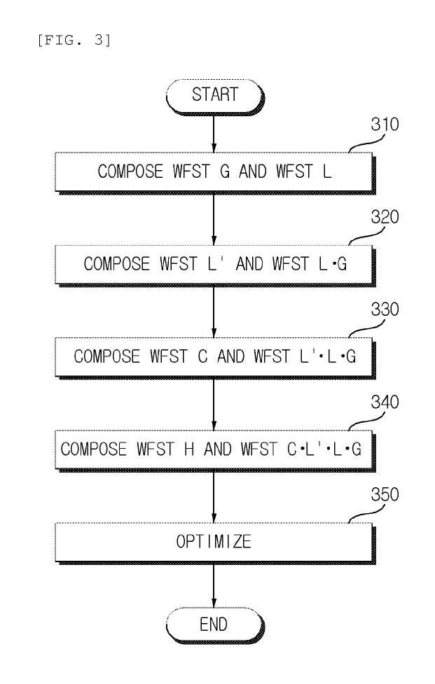

FIG. 3 is a flowchart illustrating a method of generating a search network for voice recognition according to an exemplary embodiment of the present invention. The method of generating the search network for voice recognition according to the exemplary embodiment of the present invention includes steps performed in the aforementioned system for generating the search network for voice recognition. Accordingly, although the contents are omitted, the aforementioned contents in relation to the system for generating the search network for voice recognition are also applied to the method of generating the search network for voice recognition according to the exemplary embodiment of the present invention.

The WFST composition unit 220 generates WFST L∘G by composing WFST G and WFST L (step 310).

The WFST composition unit 220 generates WFST L′∘L∘G by composing WFST L′ and the WFST L∘G (step 320).

The WFST composition unit 220 generates WFST C∘L′∘L∘G by composing WFST C and the WFST L′∘L∘G (step 330).

The WFST composition unit 220 generates WFST H∘C∘L′∘L∘G by composing WFST H and the WFST C∘L′∘L∘G (step 340).

The WFST optimization unit 230 optimizes the WFST H∘C∘L′∘L∘G (step 350).

Depending on a case, step 340 may be omitted and the WFST optimization unit 230 may optimize the WFST C∘L′∘L∘G in step 350. Depending on a case, steps 310 to 330 may include a process of optimizing the generated WFST L∘G, WFST L′∘L∘G, and WFST C∘L′∘L∘G, respectively.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of generating a search network for voice recognition, the method comprising:
generating a pronunciation transduction weighted finite state transducer by implementing a pronunciation transduction rule representing a phenomenon of pronunciation transduction between recognition units as a weighted finite state transducer; and
composing the pronunciation transduction weighted finite state transducer and one or more weighted finite state transducers.

2. The method of claim 1, wherein the pronunciation transduction rule is represented in a form of a phoneme sequence.

3. The method of claim 1, wherein the recognition unit is a word.

4. The method of claim 1, wherein the generating of the pronunciation transduction weighted finite state transducer comprises generating the pronunciation transduction weighted finite state transducer based on a context independent phoneme and the pronunciation transduction rule.

5. The method of claim 1, wherein an input and an output of the pronunciation transduction weighted finite state transducer are context independent phonemes.

6. The method of claim 1, wherein the composing of the pronunciation transduction weighted finite state transducer and the one or more weighted finite state transducers comprises:
composing a grammar weighted finite state transducer and a pronunciation dictionary weighted finite state transducer; and
composing the pronunciation transduction weighted finite state transducer and the composed weighted finite state transducer.

7. The method of claim 6, wherein the composing of the pronunciation transduction weighted finite state transducer and the one or more weighted finite state transducers further comprises composing a context weighted finite state transducer and a weighted finite state transducer that is composed with the pronunciation transduction weighted finite state transducer.

8. The method of claim 7, wherein the composing of the pronunciation transduction weighted finite state transducer and the one or more weighted finite state transducers further comprises composing an HMM weighted finite state transducer and a weighted finite state transducer that is composed with the context weighted finite state transducer.

9. The method of claim 1, further comprising:
optimizing a weighted finite state transducer that is composed with the pronunciation transduction weighted finite state transducer.

10. A system for generating a search network for voice recognition, the system comprising:
a storage unit for storing a pronunciation transduction weighted finite state transducer in which a pronunciation transduction rule representing a phenomenon of pronunciation transduction between recognition units is implemented as a weighted finite state transducer; and
a WFST composition unit for composing the pronunciation transduction weighted finite state transducer to one or more weighted finite state transducers.

11. The system of claim 10, wherein the pronunciation transduction rule is represented in a form of a phoneme sequence.

12. The system of claim 10, wherein the recognition unit is a word.

13. The system of claim 10, wherein the pronunciation transduction weighted finite state transducer is generated based on a context independent phoneme and the pronunciation transduction rule.

14. The system of claim 10, wherein an input and an output of the pronunciation transduction weighted finite state transducer are context independent phonemes.

15. The system of claim 10, wherein the WFST composition unit composes a grammar weighted finite state transducer and a pronunciation dictionary weighted finite state transducer, and composes the pronunciation transduction weighted finite state transducer and the composed weighted finite state transducer.

16. The system of claim 15, wherein the WFST composition unit composes a context weighted finite state transducer and a weighted finite state transducer composed with the pronunciation transduction weighted finite state transducer.

17. The system of claim 16, wherein the WFST composition unit composes an HMM weighted finite state transducer and a weighted finite state transducer composed with the context weighted finite state transducer.

18. The system of claim 10, further comprising:
a WFST optimization unit for optimizing a weighted finite state transducer composed with the pronunciation transduction weighted finite state transducer.
